(19) United States
(12) Patent Application Publication
(10) Pub. No.: US 2010/0257124 A1
(43) Pub. Date: Oct. 7, 2010

(54) Method for industrial energy and emissions investment optimization

(76) Inventor: Ramesh Srinivasan, San Jose, CA (US)

Correspondence Address: RAMESH SRINIVASAN, 7190 SILVER LODE LANE, SAN JOSE, CA, 95120, US

(21) Appl. No.: 12/798,617

(22) Filed: Apr. 7, 2010

Related U.S. Application Data
(60) Provisional application No. 61/212,197, filed on Apr. 7, 2009.

(51) Int. Cl. G06Q 10/00; G06Q 99/00; G06Q 40/00

(52) U.S. Cl. 705/36 T; 705/348

(57) ABSTRACT

The invention is an optimization method comprising of: (a) uniform and efficient model and associated methods for computing the energy and emission impacts of each of a range of technological and commercial options, and (b) an integrated and efficient optimization model for trading off the technological and commercial options against each other to arrive at a financially optimal solution that complies with regulatory caps on emission. The energy and emission impact model handles options such as energy efficiency measures, renewable energy projects, carbon capture projects and carbon offsets. In addition to handling the direct emissions, the model handles indirect emissions resulting from purchased electricity or fuel. The integrated optimization model selects the solution that maximizes the total net present value of savings across the various technological and commercial options considering the location specific rates, prices and carbon caps as well as the different levels of investments within each project to choose from; this model performs this optimization over a series of time periods respecting capital budget and operational budget constraints. The quantities of carbon offsets that must be purchased or sold are also determined as part of this integrated model.

### BACKGROUND OF THE INVENTION

This invention is in the field of helping businesses strike a balance between corporate energy and emission reduction costs and the costs of environmental compliance. The energy costs are expected to continue to increase in the future. According to the estimates from the U.S. Environmental Protection Agency, aggregated energy consumption across many of the manufacturing sectors is projected to increase by 20 percent from 2004 levels by 2020, and CO₂e emissions (i.e. CO₂ equivalent emissions for all the six green house emission gases) are projected to increase by 14 percent (“Energy Trends in Selected Manufacturing Sectors: Opportunities and Challenges for Environmentally Preferable Energy Outcomes”, U.S. Environmental Protection Agency, March 2007). The volumes of green house gas emissions are expected to continue to rise in the future. In California, for example, the emission levels are projected to grow from a 2004 level of 500 MMT CO₂e to 600 MMT CO₂e by 2020 unless new actions are taken (2007 Integrated Energy Policy Report, California Energy Commission).

Governments at the international, national and state levels are working on measures to curb such emissions. Schemes that are being considered are: 1. Cap and Trade, 2. Carbon Tax, 3. Hybrid of Caps and Carbon Tax, and several others. These schemes are aimed at reducing green house gas emissions by directly setting limits or caps on emissions or indirectly by penalizing emissions.

As an example, California, as part of the Western Climate Initiative, has the following time table for a Cap and Trade scheme (“Implementing a Quantitative Limit on the Use of Offsets in a Cap and Trade Program”, Mar. 23, 2009, California Air Resources Board):

The state cap establishes the limit on state CO₂e emissions and will issue CO₂e allowances to emitting entities. The scope of entities planned by California is as follows:

2012-2014
In-State Electricity Generation Facilities (>25,000 MT CO₂e/year) and Imported Electricity
Large Industrial Facilities (>25,000 MT CO₂e/year)
2015-2020
‘Upstream’ treatment of fuel combustion where fuel enters into commerce covering
Small industrial fuel use (for facilities <25,000 MT CO₂e/year)
Residential and commercial fuel use
Transportation fuel use

Note that each CO₂e allowance represents a permit to emit one ton of CO₂e. State control over the number of issued allowances ensures that total emissions will not exceed the cap.

Given the conflicting requirements of increasing energy costs and having to reduce green house gas emissions, businesses need to: a) evaluate all options, and b) arrive at one or more options that offer the least cost way to meet the energy demands while also satisfying emissions limits and regulations. The solution approaches that already exist deal with the energy requirements and GHG emission requirements separately and inadequately. Usually these are two different departments or activities that come up with their plans independently. Even when they do work together, this is usually restricted to looking at a single process improvement opportunity at a time.

The following means for energy and emission reduction must be considered simultaneously so as to trade one means against another to arrive at the least cost plan:

1. Energy Efficiency measures

2. Reducing GHG emissions through carbon avoidance and carbon capture strategies

3. Purchasing additional emission allowances/Carbon Offsets/Renewable Energy Credits

The costs of the options above are different by location and time period. Different combinations must be looked at for obtaining the least cost solution.

The existing work addresses energy cost budgeting and management (U.S. Patent Application 20060161450-“Method and system for tracking and budgeting energy usage”, Carey, Margaret M., Pfeister, Douglas L., Putnam, Christopher) and emissions trading (U.S. Patent Application 20060184445-“Systems and methods for trading emission reductions”, Sandor, Richard, Walsh, Michael, Kanakasabai, Murali). Organized methods and systems for storing, retrieving and interacting with energy and environmental programs have been proposed (Benedek, Z., Liang, J. and Wenegrat, J, “System for Providing Strategies to Reduce the Carbon Output and Operating Costs of a Workplace”, U.S. Pat. No. 0,204,916, issued Aug. 13, 2009; Beaver, E., “Means for Incorporating Sustainability Metrics and Total Cost Benefit Analysis in Decision-Making”, U.S. Pat. No. 0,222,307, issued Sep. 3, 2009; Esposito II, P. R., Harvey, C. M., Esposito, M. V., Thomas, G. K., Williams II, J. P., Gandee, J. E., Esposito SR., P. R., Locke, C. D., Wood, J. M., “Management Method, System and Product for Enterprise Environmental Programs”, U.S. Pat. No. 0,015,424, issued Jan. 19, 2006). However, optimizing in an integrated manner energy costs and GHG Emission Compliance costs across multiple projects and locations has not been addressed. This is the subject of the current invention.

Investment in energy efficiency, clean energy, carbon reduction and carbon off-sets is fundamentally a business decision, and the success of strategies to promote environmentally preferable energy outcomes will depend primarily on the business case for such investments.

### SUMMARY OF THE INVENTION

The invention is an optimization method comprising of: (a) uniform and efficient model and associated methods for computing the energy and emission impacts of each of a range of technological and commercial options, and (b) an integrated and efficient optimization model for trading off the technological and commercial options against each other to arrive at a financially optimal solution that complies with regulatory caps on emission. The energy and emission impact model handles options such as energy efficiency measures, renewable energy projects, carbon capture projects and carbon offsets. In addition to handling the direct emissions, commonly referred to as Scope 1 emissions, the model handles indirect emissions resulting from purchased electricity or fuel, commonly referred to as Scope 2 emissions. The integrated optimization model selects the solution that maximizes the total net present value of savings across the various technological and commercial options considering the location specific rates, prices and carbon caps as well as the different levels of investments within each project to choose from; this model performs this optimization over a series of time periods respecting capital budget and operational budget constraints. The quantities of carbon offsets that must be purchased or sold are also determined as part of this integrated model.

### BRIEF DESCRIPTION OF THE DRAWINGS

FIG. 1 illustrates a high level flow diagram describing the overall method of the invention.

FIG. 2 illustrates a high level flow diagram describing the energy and emission impact computational model for a project.

FIG. 3 illustrates how different project types of projects (Energy Efficiency, Renewable Energy, Carbon Capture and Carbon Offsets) impact Costs and Energy Efficiency and Emission

FIG. 4 illustrates the cost-benefit tradeoff for an Energy Efficiency project.

FIG. 5 illustrates the cost-benefit tradeoff for a Renewable Energy project.

FIG. 6 illustrates the cost-benefit tradeoff for a Carbon Capture project.

FIG. 7 illustrates the cost-benefit tradeoff for a Carbon Offset as a commercial option

FIG. 8 illustrates a high level flow diagram of the optimization model that selects the optimal mix of energy and emission projects.

FIG. 9 illustrates machine implementation of the present invention.

### DETAILED DESCRIPTION OF THE INVENTION

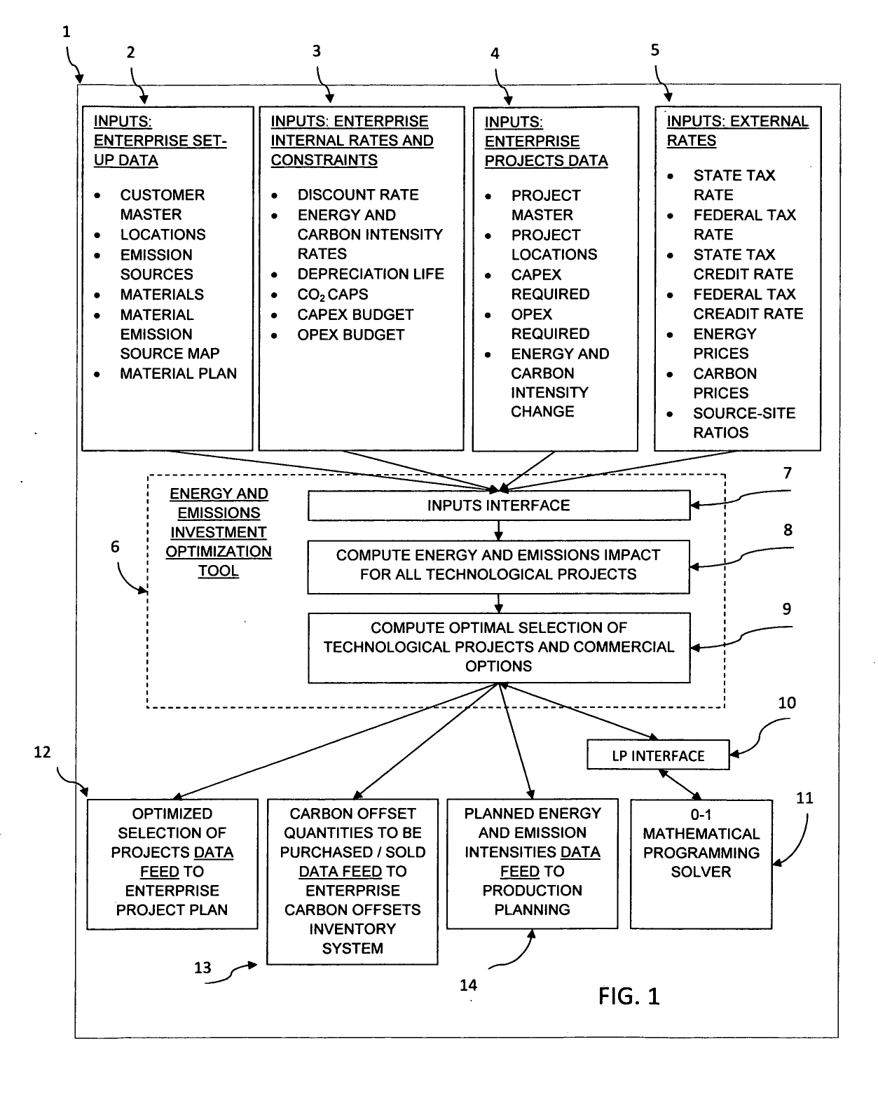

The invention is the method (box 6) of selecting an optimal mix of energy efficiency and emission abatement projects, which is comprised of two major stages: I. computing the impact of each energy efficiency and emission abatement project; II. selecting an optimal mix of projects that considers business objectives and business factors and satisfy business constraints. Referring to FIG. 1, boxes 2-5 represent the inputs to this method, which are communicated to the method through inputs interface (box 7). The two stages in the method are represented by boxes 8 and 9 respectively. Box 10 represents a standard interface to a commercial solver; box 11 represents a commercial mathematical program solver; box 12 represents an enterprise storage for storing Energy and Emissions Project Plans; box 13 represents an enterprise storage for Carbon Offsets Inventory. Before continuing, the following are terminology definitions which will be sued herein.

### TERMINOLOGY

### Inputs: Enterprise Set-up Data (box 2)

n location

m material

p emission source; this index is unique to the enterprise across all locations

f fuel type

t time period (year)

Vₘₙₜ volume of material m processed at location n in time period t

### Inputs: Enterpise Internal Rates and Constraints (box 3)

d discount rate (%)

G_{mpft} energy intensity rate for processing material m at emission source p with fuel f in time period t, expressed as Mbtu/unit material processed; Mbtu stands for Million British Thermal Units.

E_{mpft} for emission caused as a by-product of the processing, emission intensity rate for processing material m at emission source p with fuel f in time period t, expressed as kgC/unit material processed; kgC stands for kilogram of carbon equivalent of a green house gas.

I depreciation life

Pₙₜ CO₂e cap in location n in period t

Kₜ^{F} capital expenditure budget in period t

Kₜ^{O} operational expenditure budget in period t

### Inputs: Enterprise Projects Data (box 4)

q project

i project level; higher the level, typically, larger the investment

C_{ntqj}^{F} capital expenditure required for project q and level j at location n in time period t

C_{ntqj}^{O} operational expenditure required for project q and level j at location n in time period t

C_{tq}^{Fh} capital expenditure required for project q and level j at HQ location in time period t

C_{tq}^{Oh} operational expenditure required for project q and level j at HQ location in time period t

NC_{ntqj}^{F} net present value of capital expenditure required for project q and level j at location n in time period t

NC_{ntqj}^{O} net present value of operational expenditure required for project q and level j at location n in time period t

NC_{tq}^{Fh} net present value of capital expenditure required for project q at HQ location in time period t

NC_{tq}^{Oh} net present value of operational expenditure required for project q at HQ location in time period t

g_{mpftqj} change in energy intensity rate (G_{mpft}) caused by project q and level j, expressed as Mbtu/unit material processed

u_{f} CO₂e equivalent emission intensity of fuel f, expressed as kgC/Mbtu

e_{mpftqj} change in emission intensity rate (E_{mpft}) caused by project q and level j, expressed as kgC/unit material processed

### Inputs: External Rates (box 5)

Aₙₜ state tax rate for location n (depending upon state where location is situated) in time period t

Bₙₜ federal tax rate for location n (depending upon country where location is situated)

C_{nqt} state tax credit rate for project q at location n in time period t; the rate will depend upon the type of project such as Energy Efficiency, Renewable Energy, Carbon Capture

D_{nqt} federal tax credit rate for project q at location n in time period t; the rate will depend upon the type of project such as Energy Efficiency, Renewable Energy, Carbon Capture

P_{nft} energy price for fuel f at location n in time period t, expressed as $/Mbtu

Qₙₜ price of carbon at location n in time period t, expressed as $/kgC

S_{fnt} source-site ratio for fuel f at location n in time period t

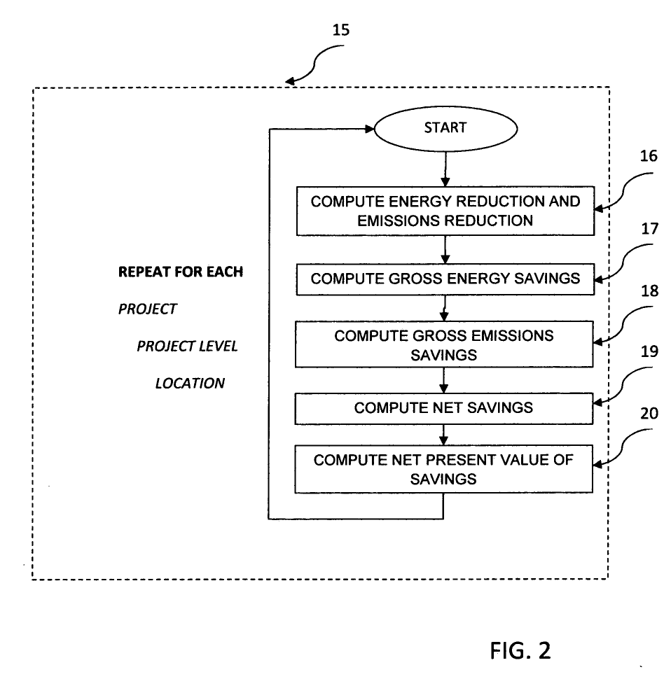

The computation of energy and emissions impact in box 8 is presented in more detail in FIG. 2 through a series of steps represented by boxes 16-20 executed for each project q, level j and location n.

The computation of energy reduction and emission reduction (box 16) is first described. A project q may affect the processing of one or more materials m, being processed at one or more emission sources p, utilizing one or more fuels f. Depending on the project level j, the effects on energy consumption and emission may be different for the same project. The change in energy intensity, i.e., the amount of energy consumed in the processing of one unit amount of material, is computed as:

g_{mpftqj}=G_{mpft}(before project)−G_{mpft}(after project) (eq.1)

When Σ_{mpft}g_{mpftqj}≧0, the project q and level j has resulted in energy savings, which a gain of energy efficiency. The energy savings measured in energy units (Mbtu) for a project q and level j over a series of periods is expressed as:

$${\sum }_{mpft} {v}_{mnt} \times {g}_{mpftqj} \qquad ( eq . 2 )$$

The change in emissions resulting from a project can be of two types: energy use based emission reduction (EUER) and process by-product emission reduction (PER). EUER is the emission reduction resulting from energy reduction; a positive value is reduction, while negative value is emission increase. EUER is thus directly based on energy savings from eq. 2. However, this reduction must be inflated by a factor called source-site ratio to account for primary energy, i.e., energy at the source. For example, in the case of electricity, any reduction at the site must be inflated by the source-site ratio (S_{fnt}) to account for transmission and generation losses incurred en route from the source to the site. Thus,

$${EUER}_{qjn} = {\sum }_{mpft} {v}_{mnt} \times {g}_{mpftqj} \times {u}_{f} \times {s}_{fnt} \qquad ( eq . 3 )$$

Process by-product emission reduction (PER), on the other hand, results as a by-product in the process. An example is the release of CO₂e during the calcination process in cement manufacturing.

$${PER}_{qjn} = {\sum }_{mpt} {v}_{mnt} \times {e}_{mpftqj} \qquad ( eq . 4 )$$

PER is also classified as Scope 1 or direct emission, and EUPR is classified as Scope 2 or indirect emission.

Gross energy savings (GES) (box 17) is computed in dollar units ($) for a project q and level j at location n over a series of periods as:

$${GES}_{qjn} = {\sum }_{mpft} {v}_{mnt} \times {g}_{mpftqj} \times {P}_{nft} \qquad ( eq . 5 )$$

where P_{nft} is the price/Mbtu for fuel f at location n in time period t.

Gross emission savings (GMS) (box 18) is computed in dollar units ($) for a project q and level j at location n over a series of periods as:

$${GMS}_{qjn} = {\sum }_{t} ( {EUER}_{qjn} + {PER}_{qjn} ) \times {Q}_{n t} \qquad ( eq . 6 )$$

where Qₙₜ is the price of carbon. This monetization of emission savings will be addressed as part of the optimization across multiple projects (box 9) to be described later.

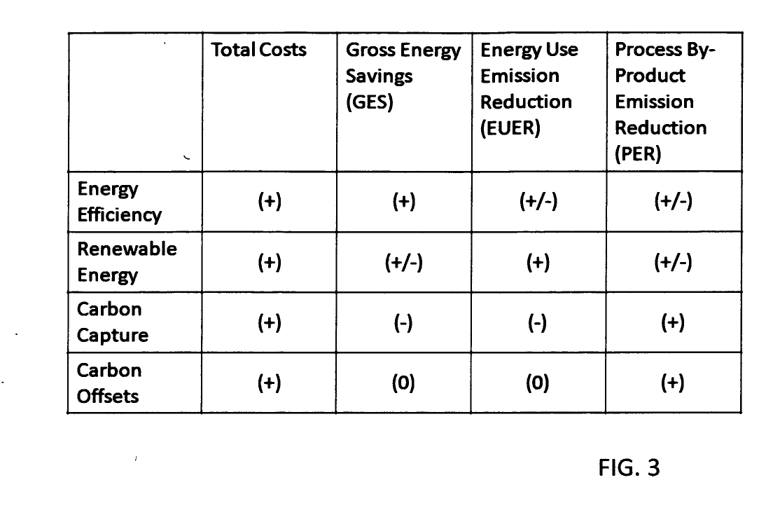

The invention described here includes a uniform energy and emission model to support different types of projects: Energy Efficiency, Renewable Energy, Carbon Capture and Carbon Offsets. Note that Carbon Offsets refer to tradable Carbon Credits, not the projects to develop Carbon Offsets. This uniform model consists of four high level components: Total Costs, Gross Energy Savings (GES), Energy Use Emission Reduction (EUER) and Process By-Product Emission Reduction (PER). Each of the project types listed above is modeled using the four components of the uniform energy and emission model described above. Each project may contribute to each of the model components differently, i.e., positively or negatively. This is illustrated in FIG. 3. For example, when an Energy Efficiency project is implemented, Total Costs are incurred (positive), GES is expected to be positive (very reason for performing an Energy Efficiency project), EUER may be positive or negative depending upon the type of fuels used in the place of the existing fuels, and PER may be positive or negative depending upon the changes to process if any. This uniform energy and emission model facilitates the formulation of an overall optimization across multiple projects to be discussed later (box 9).

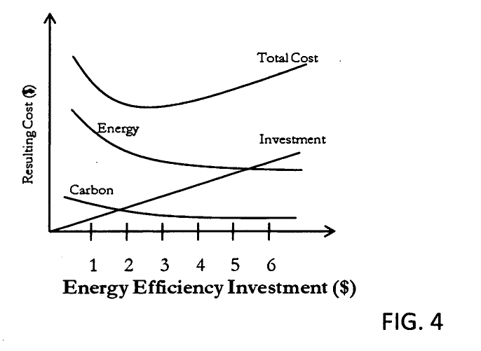

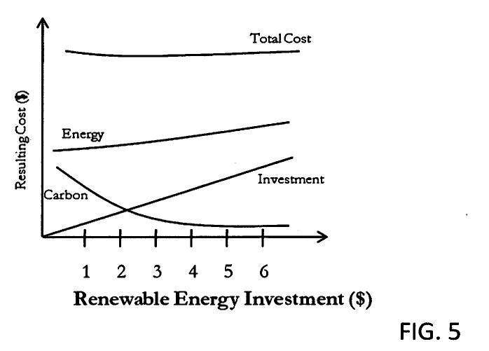

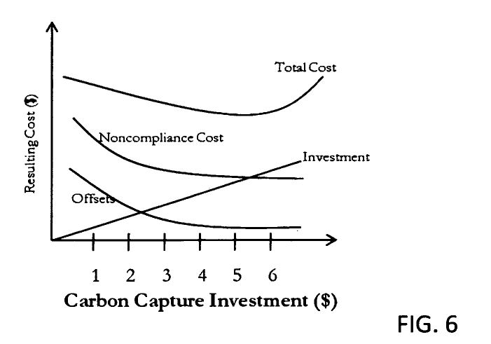

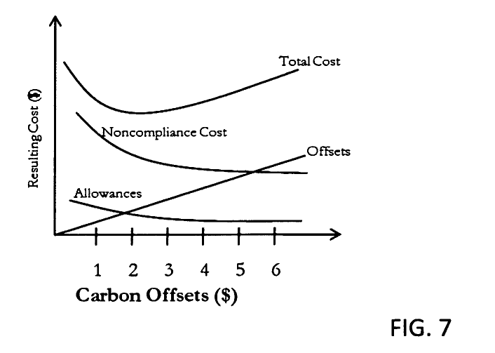

Continuing with the same example (an Energy Efficiency project), the Total Costs will likely go up when the investment is increased so as to achieve higher energy efficiency with the same technology. This is illustrated in FIG. 4. Also illustrated are the energy and emission (carbon) costs in the same figure. The level of investment (j) for this project (q) is shown on the x-axis. For each level of investment, the corresponding levels of energy costs/savings and emission costs/savings are also illustrated in FIG. 4. These are computed in boxes 16-18 as described previously. The level (j) of investment for project q is a decision variable in the optimization model to be described in box 9. For modeling convenience, the level j of investment is one of a discrete number of levels for a project, which is typically between 0 and 5. FIG. 5-7 illustrate the cost and savings interactions for Renewable Energy, Carbon Capture and Carbon Offsets projects.

The Net Savings (box 19) for a project q and level j at a location n are computed by subtracting from gross energy and emission savings the costs and taxes, while accounting for depreciation and tax credits. The following standard steps are executed in box 19 for a project q, level j and at location n and for each time period:
1. Add gross energy savings and emission savings obtained from eq. 5 and eq. 6.
2. Add capital expenditures and operational expenditures: C_{ntqj}^{F}+C_{ntqj} ^{O}
3. Obtain gross income by subtracting total expenditures in Step 2 from gross savings in Step 1.
4. Depreciation is calculated using standard Straight Line method or Double Declining method with life I. Subtract depreciation from result of Step 3. This is State Taxable Income.
5. Compute Unadjusted State Tax on State Taxable Income from Step 4.
6. Subtract State Tax Credit from Step. 5. This is State Tax.
7. Subtract State Tax in Step 6 from Step 4. This is Federal Taxable Income.
8. Compute Unadjusted Federal Tax on Federal Taxable Income from Step 7.
9. Subtract Federal Tax Credit from Step 8. This is Federal Tax.
10. Obtain Net Savings by subtracting State Tax and Federal Tax from the gross income in Step 3.

Net Present Value of Savings (box 20) is computed for a project q, level j at a location n for a time period t as follows:

$$Net Present {Value}_{qjnt} = \frac{( Net Savings from box 19 , Step 10 )}{{( 1 + \frac{d}{100} )}^{t - c}} \qquad ( eq . 7 )$$

where (t−c) is the number of years for which the Net Savings is to be discounted.

Upon completion of the Net Present Value of Savings (box 20) for all project levels and locations, the inputs for the optimization across multiple projects (box 9) are now ready.

### ADDITIONAL TERMINOLOGY

χ_{ntqj} project binary variable; 1 if project q and level j is selected at location n in time period t, 0 if not selected

Z_{tq} corporate project binary variable; 1 if project q is selected at any location for any level in period t, 0 otherwise

E_{ntf} dollar value of projected energy consumption at location n for fuel f in period t

ΔE_{pntfqj} Net present value dollar value of computed fuel reduction based savings resulting from project q and level j in the processing of materials at emission source p in location n in period t

ε_{ntf} dollar value of projected CO₂e emission at location n for fuel f in period t

Δε_{pntfqj} Net present value dollar value of computed emission savings resulting (NPV of GMS) from project q and level j in the processing of materials at emission source p in location n in period t

Planned emission at a location n in time period t (Lₙₜ) needs to be computed in order to determine carbon offsets excess or deficit. As presented previously in equations 3 and 4, the emissions of both types, EUER and PER need to be accounted for.

$$\begin{matrix}{EUER}_{nt} = {\sum }_{mpfqj} {v}_{mnt} \times {g}_{mpftqj} \times {u}_{f} \times {s}_{fnt} \times {x}_{ntqj} & ( eq . 8 ) \\ {PER}_{nt} = {\sum }_{mpqj} {v}_{mnt} \times {e}_{mpftqj} \times {x}_{ntqj} & ( eq . 9 )\end{matrix}$$

Planned emission at location n in time period t based on projects selected χ_{ntqj}:

$${L}_{nt} = {\sum }_{mpf} {v}_{mnt} \times ( {G}_{mpft} \times {u}_{f} \times {s}_{fnt} + {E}_{mpft} ) - {EUER}_{nt} - {PER}_{n t} \qquad ( eq . 10 )$$

Kₜ^{F} capital budget in period t

Kₜ^{O} operational budget in period t

c current year

r number of years into future

β number of emission sources

α number of locations

χ number of fuel types

ν number of projects

γnumber of project levels

λ number of plan years

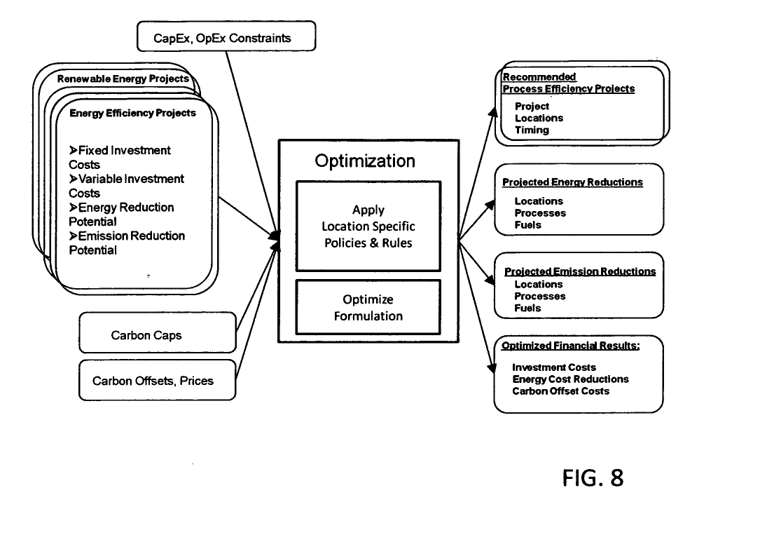

The optimization is a 0-1 mathematical programming formulation to select the optimal mix of projects q, each with corresponding level j and the locations where the project is to be implemented. The objective function minimizes the (Cost−Savings). The business constraints include constraints for not exceeding the capital budget and operational budget. The problem inputs and outputs are laid out in FIG. 8.

Min:

$${\sum }_{n = 1}^{α} {\sum }_{t = c + r}^{λ} {\sum }_{q = 1}^{v} {\sum }_{j = 1}^{γ} {NC}_{ntqj}^{F} [ {x}_{ntqj} ]$$

(sum of location capital expenditures for selected projects)

$$+ {\sum }_{n = 1}^{α} {\sum }_{t = c + r}^{λ} {\sum }_{q = 1}^{v} {\sum }_{j = 1}^{γ} {NC}_{ntqj}^{O} [ {x}_{ntqj} ]$$

(sum of location operational expenditures for selected projects)

$$+ {\sum }_{t = c + r}^{λ} {\sum }_{q = 1}^{v} {NC}_{tq}^{Fh} [ {z}_{tq} ]$$

(sum of corporate capital expenditures for selected projects)

$$+ {\sum }_{t = c + r}^{λ} {\sum }_{q = 1}^{v} {NC}_{tq}^{Oh} [ {z}_{tq} ]$$

(sum of corporate operational expenditures for selected projects)

$$- {\sum }_{n = 1}^{α} {\sum }_{t = c + r}^{λ} {\sum }_{q = 1}^{v} {\sum }_{j = 1}^{γ} [ {\sum }_{f = 1}^{χ} {\sum }_{p = 1}^{β} Δ {E}_{pntfqj} ] {x}_{ntqj}$$

(NPV sum of energy savings, box 20)

$$- {\sum }_{nt} ( {L}_{nt} - {P}_{nt} ) \times {Q}_{nt}$$

(Dollar value of Carbon Offsets Purchased or Sold)

subject to

$${\sum }_{j = 1}^{γ} {x}_{ntqj} \leq 1$$

∀t,n,q (at a location only one level of a project should be implemented)

χ_{ntqj}≧χ_{nt-1qj} ∀t,n,q, j (project level selected in a year is selected for the next year and for life of project)

$${\sum }_{t = c}^{c + r - 1} {x}_{ntqj} = 0$$

∀n,q, j (a project is not in progress at a location until future year r from current year c)

$${\sum }_{t = c}^{c + r - 1} {z}_{tq} = 0$$

∀q (a project is not in progress at corporate location until a future year r from current year c)

Z_{tq}≧Z_{t-1q} ∀t,q (at corporation, project selected in a year is selected for the next year and for life of project)

$${\sum }_{n = 1}^{α} {\sum }_{j = 1}^{γ} {x}_{ntqj} \leq M * {z}_{tq}$$

∀t,q (M is a large integer. Condition required to make corporate cost to be included if any one of the locations is selected for a project-level)

$${\sum }_{q = 1}^{v} [ ( {\sum }_{j = 1}^{γ} {\sum }_{n = 1}^{α} {C}_{ntqj}^{F} {x}_{ntqj} ) + {C}_{tq}^{Fh} [ {z}_{tq} ] ] \leq {K}_{t}^{F}$$

∀t (Capital Expenditures per period including corporate costs must be less than allocated fixed investment budget)

$${\sum }_{q = 1}^{v} [ ( {\sum }_{j = 1}^{γ} {\sum }_{n = 1}^{α} {C}_{ntqj}^{O} {x}_{ntqj} ) + {C}_{tq}^{Oh} [ {z}_{tq} ] ] \leq {K}_{t}^{O}$$

∀t (Operational Expenditures per period including corporate costs must be less than allocated operational budget)

χ_{ntqj}ε{0,1} (1-project selected, 0-project not selected)

This problem is solved using a standard mathematical solver. The solution yields the following:
1. Selection of which project, q, at which level j, at which location n
2. At each location n and time period t, the Carbon Offsets purchased (Lₙₜ−Pₙₜ) or sold (Pₙₜ−Lₙₜ)

### IMPLEMENTATION

Implementation of the energy and emission computational method: The inputs listed in boxes 2-5 are uploaded through standard spreadsheet upload interface provided for in box 7. The computations in box 8 are performed through the steps 16-20 for each project q, level j and location n. This results in the computation of Total Costs, Energy Savings and Emission Savings for each project q, level j and location n.

Implementation of optimization across projects: Based on the inputs for capital budget, operational budget and carbon caps input through boxes 3 and 5, the optimization problem in box 9 is automatically formulated. Then the formulation is output as a standard MPS file. A commercial mathematical solver is then invoked to obtain an optimal solution.

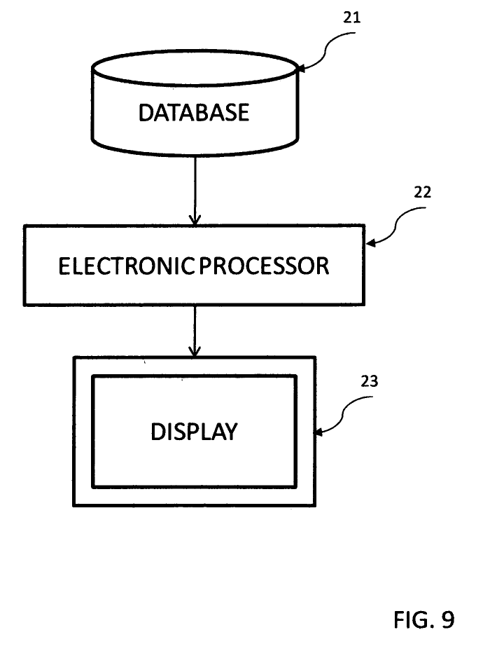

Machine Implementation: Attention is now directed to FIG. 9, which illustrates a preferred machine implementation of the present invention. In particular, FIG. 9 comprises a database 21 that stores the inputs listed in boxes 2-5, an electronic processor 22, and a conventional output display 23. In operation the processor and the display act on the data stored in the database to compute Total Costs, Energy Savings and Emission Savings for each project q, level j and location n; then based on user request for optimization, the system solves the optimization across projects by automatically formulating the optimization model, preparing a standard MPS file, and invoking a commercial solver.

We claim:

1. An optimization method to determine the selection of energy and emission abatement projects for a multinational industrial enterprise over a series of time periods considering both technological projects and commercial options available, such determination including the project implementation decisions pertaining to the locations and complexity or level of each of the projects selected, such determination based on the business objective to maximize the totality of energy and emission related savings accrued in excess of the capital expenditures and operational expenditures incurred by the selected projects and penalties incurred for exceeding the green house gas emission caps at each location in the enterprise, such determination satisfying capital budget constraints and operational budget constraints over a series of time periods, the optimization method comprising the steps of:
a. Compute the optimal mix of technological projects that minimizes the sum of capital expenditures, operational expenditures and carbon offsets and maximizes the Net Present Value of energy savings, using the 0-1 mathematical formulation provided
b. Compute the carbon offsets that can be sold at a location in a time period
c. Compute the carbon offsets that must be purchased at a location in a time period

2. A method according to claim 1, where the said energy savings and emission savings for each project are derived computationally based on an energy and emission impact computational method with method inputs comprising, period specific volumes of materials processed in multiplicity of locations, each location comprising multiplicity of emission sources, each material being processed at multiplicity of such emission sources, each project contributing specified reductions or increases to energy intensity and emission intensity of a specific emission source for a specific material, fuel and time period, the method inputs further including energy prices and carbon prices at different locations in different time periods, energy tax credits specific to the location, type of project and time period of implementation of each project, state and federal tax rates applicable to the project specific to each location and time period when the selected project is determined to be implemented, depreciation rule to be applied to amortize the capital expenditure, the discount rate to be applied to determine the net present value of energy and emission savings, the method comprising the steps of:
a. Apply to each project the energy and emission impact computational method comprising the steps of:
i. Compute energy reduction or increase (scope 1)
ii. Compute emission reduction or increase (scope 1)
iii. Compute emission reduction or increase (scope 2)
iv. Compute gross energy savings
v. Compute gross emission savings
vi. Compute depreciation
vii. Compute state taxable income
viii. Compute state tax credit
ix. Compute state tax
x. Compute federal taxable income
xi. Compute federal tax credit
xii. Compute federal tax
xiii. Compute Net Savings
xiv. Compute Net Present Value of Net Savings

3. A method according to claim 2, where the energy and emission impact computational method is particularized for Energy Efficiency per table in FIG. 3.

4. A method according to claim 2, where the energy and emission impact computational method is particularized for Renewable Energy per table in FIG. 3.

5. A method according to claim 2, where the energy and emission impact computational method is particularized for Carbon Capture per table in FIG. 3.

6. A method according to claim 2, where the energy and emission impact computational method is particularized for Carbon Offsets per table in FIG. 3.
